(19) United States
(12) Patent Application Publication
(10) Pub. No.: US 2006/0059446 A1
(43) Pub. Date: Mar. 16, 2006

(54) Sensitivity based statistical timing analysis

(76) Inventors: Thomas W. Chen, Fort Collins, CO (US); Eugene Berta, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/940,099

(22) Filed: Sep. 14, 2004

(51) Int. Cl. G06F 17/50

(52) U.S. Cl. 716/6

(57) ABSTRACT

One disclosed embodiment may comprise a system that includes design data that describes at least a portion of a circuit design. An analysis system determines timing information for a node associated with a first component of the circuit design relative to variations in a parameter associated with at least one second component of the circuit design. The timing information for the node associated with the first component characterizes a sensitivity of the first component relative to the variations in the parameter associated with the at least one second component.

### BACKGROUND

Various timing analysis tools have been developed for use in designing integrated circuits. Traditional tools perform timing analysis at selected points along paths in the circuits. Typically, such points in the path are evaluated to ascertain timing information about such points as well as about the path in general. Based on the timing information obtained from the analysis, a designer can implement changes in the circuit design, such as to improve performance of the design.

### SUMMARY

One embodiment of the present invention may comprise a system that includes design data that describes at least a portion of a circuit design. An analysis system determines timing information for a node associated with a first component of the circuit design relative to variations in a parameter associated with at least one second component of the circuit design. The timing information for the node associated with the first component characterizes a sensitivity of the first component relative to the variations in the parameter associated with the at least one second component.

Another embodiment may comprise a system that includes a simulator that determines a delay sensitivity associated with a victim of a coupled interconnect based on delay timing information for the victim of the coupled interconnect relative to at least one corresponding variation in a parameter that affects timing at the victim of the coupled interconnect. A variation calculator determines a statistical indication of delay variation for the coupled interconnect based on the delay sensitivity and a corresponding statistical parameter.

Yet another embodiment may comprise an analysis system. The analysis system include a first sensitivity calculator that determines a first delay sensitivity for a victim of a coupled interconnect with respect to variation in a signal arrival time at each of a plurality of aggressors to the victim of the coupled interconnect. A second sensitivity calculator determines a second delay sensitivity with respect to variation in a physical parameter of components that drive the respective aggressors. A variation calculator determines a statistical indication of delay variation for the coupled interconnect based on the first delay sensitivity and a first corresponding statistical parameter and based on the second delay sensitivity and a second corresponding statistical parameter.

Still another embodiment may comprise a system that includes a characterization of a component that is connected to drive an output system coupled to an output of the component. A simulation system varies at least two parameters of the output system and performs timing analysis of the characterization to generate timing data for the output of the component. A timing function is generated based on the timing data to non-linearly characterize the output timing characteristics of the circuit component according to variations in the at least two parameters of the output system.

Still another embodiment may comprise a method that includes performing timing analysis for at least a portion of a circuit design. Timing information is determined, based on the performed timing analysis, for a node associated with a first component of the at least a portion of the circuit design relative to variations in a parameter associated with at least one second component of the at least a portion of the circuit design. The timing information for the node associated with the first component characterizes a sensitivity of the first component relative to the variations in the parameter associated with the at least one second component.

Another embodiment may comprise a computer readable article having computer executable instructions for simulating operation of at least a portion of a circuit design. The computer readable article may have further computer executable instructions for calculating timing information for a node associated with a first component of the at least a portion of the circuit design relative to variations in a parameter associated with at least one second component of the at least a portion of the circuit design. The timing information for the node associated with the first component characterizes a sensitivity of the first component relative to the variations in the parameter associated with the at least one second component.

### BRIEF DESCRIPTION OF THE DRAWINGS

FIG. 1 depicts an embodiment of a system to perform sensitivity based timing analysis.

FIG. 2 depicts an embodiment of an example circuit having two coupled interconnects.

FIG. 3 depicts another embodiment of a system to perform sensitivity based timing analysis for a system having a coupled interconnect.

FIG. 4 depicts an embodiment of a system that can be utilized to derive a timing function for sensitivity based timing analysis.

FIG. 5 depicts an example of a computer system that can be employed to implement an embodiment of a method to facilitate simulation.

FIG. 6 is flow diagram depicting an embodiment of a method.

### DETAILED DESCRIPTION

FIG. 1 depicts an example of a system 10 that can be utilized to provide timing data 12 about at least a portion of a design, such as a path comprising any number of one or more components. Design data 14 characterizes the design (or a least a selected portion of a design) for which the timing data 12 is provided. As an example, the design data 14 can correspond to a netlist or other characterization of one or more circuit components such as may be represented in one or more known formats, such as Verilog, EDIF, SPICE, EPIC and SPF, or such as may be represented in a proprietary format. In one example, the design data can characterize a group of components, such as defined by a predetermined library cell or a custom cell. Thus, the design data 14 can include a description of components and interconnections that are arranged to form the circuit design or system. For example, the design data 14 can include a transistor level circuit description of component parameters, such as transistor width and channel length, VT characteristics, parameters of wires, parasitic electrical characteristics, and the like.

The system 10 includes an analysis system 16 that is operative to perform sensitivity based timing analysis for a portion of a circuit design, such as a node or a path through one or more components, based on the design data 14. The sensitivity based timing analysis enables the timing data 12 to provide information indicative of timing variations associated with a component or a path of interest, which timing variations can vary based on parameters associated with surrounding circuitry. The parameters can include physical parameters, such as transistor geometry (e.g., width, channel length), as well as more abstract parameters, such as arrival times of signals at inputs of adjacent circuitry.

According to a first example, the timing analysis system 16 can provide the timing data 12 to include delay variations associated with a coupled interconnect. The delay variations for the coupled interconnect can correspond to sensitivity based variations in relative arrival times between aggressors and victims, as well as include sensitivity based variations in the parameters of the driving components (e.g., transistor geometry). As used herein, the relationship between a victim line and an aggressor line is a relative one for a given analysis perspective, in which an interconnect that is affected by the coupling from a neighboring interconnect is referred to as the victim, and the neighboring interconnect affecting the victim is referred to as the aggressor. Thus, the arrival times of signals on aggressors to the coupled interconnects can impact the wire delays of the victim of the coupled interconnect.

To quantify the delay variations for a coupled interconnect that are attributable to one or more aggressors, the analysis system 16 employs a timing analysis engine 18 that performs timing analysis on corresponding design data to determine nominal timing data 20, such as for gate level design data 14. The nominal timing data 20 can include nominal delays for logic, including upstream aggressors and the victim of interest. The nominal timing data 20 thus provides an indication of timing characteristics for corresponding circuitry, excluding the impact due to coupling of the coupled interconnect.

A simulation block 22 is operative to perform one or more simulations in conjunction with the timing analysis engine 18 for providing the timing data 12. The simulations can include determining statistical mean delay variations for each component in the circuitry being analyzed. When a given component includes multiple inputs, statistical delay variations can also be determined based on possible variations in input-to-input arrival times for the given component.

The simulation block 22 can also include a parameter sensitivity function 24 that ascertains a victim's delay sensitivity with respect to one or more parameters that may affect variations in delay at the victim of the coupled interconnect. For example, the sensitivity function 24 can determine the victim's delay sensitivity with respect to arrival times at each aggressor based on relevant nominal timing data. An associated variation calculator 26 can determine victim delay variation (e.g., as a standard deviation) that is attributable to the variations in the aggressor arrival time based on the determined delay sensitivity for each aggressor.

The parameter sensitivity function 24 can also determine the victim's delay sensitivity with respect to one or more other parameters, including physical parameters (e.g., transistor geometry) for the aggressor components that are driving the aggressors lines of the coupled interconnect. The variation calculator 26 employs the physical parameter sensitivity for each of the aggressors to calculate a victim delay variation (e.g., as a standard deviation) that is attributable to the variations in the physical parameters. The simulation block 22 can provide the timing data 12 to include a statistical parameter (e.g., as a standard deviation) indicative of an aggregate victim delay variation for the coupled interconnect based on the victim delay variations attributable to the parameters for which delay sensitivity has been determined.

Additionally or alternatively, the timing analysis system 16 can provide the timing data 12 to include delay variations for a component or a combination of components (e.g., a cell) as a function of component geometry connected at the output of the component or cell. The timing analysis system 16 thus includes a parameter geometry block 28 that identifies parameters for components at the transistor level portion of the design data 14 for which timing analysis is desired. At the transistor level, the parameter geometry block 24 can vary parameters in an output system that is driven by a component or cell of interest according to the design data 14. Timing data can thus be provided for the component as the output system parameters are varied.

The simulation block 22 can generate a timing function 30 based on the timing data to non-linearly characterize the output timing characteristics of the circuit component according to variations in the parameters of the output system. The timing function 30 thus can provide a non-linear (e.g., a polynomial) function corresponding to sensitivity in output timing characteristics of the component as a function of the parameters (e.g., physical transistor parameter) of the output system being driven by the component. The simulation block 22 can employ the timing function, such as with the timing analysis block 18, to determine output timing characteristics for the component that is characterized by the timing function 30.

The timing function 26 can be computed and employed during timing analysis to determine output timing for the component. Alternatively, the timing function 26 can be predetermined, stored and invoked by the timing analysis engine 18 (or other timing analysis tool) for computing output timing variation for a given component that is characterized by the timing function 30. In this latter approach, the timing function 30 can be utilized during timing analysis (e.g., by a timing analysis tool) to determine timing information for the output of the component each time an instance of the component is encountered during the analysis of a circuit design.

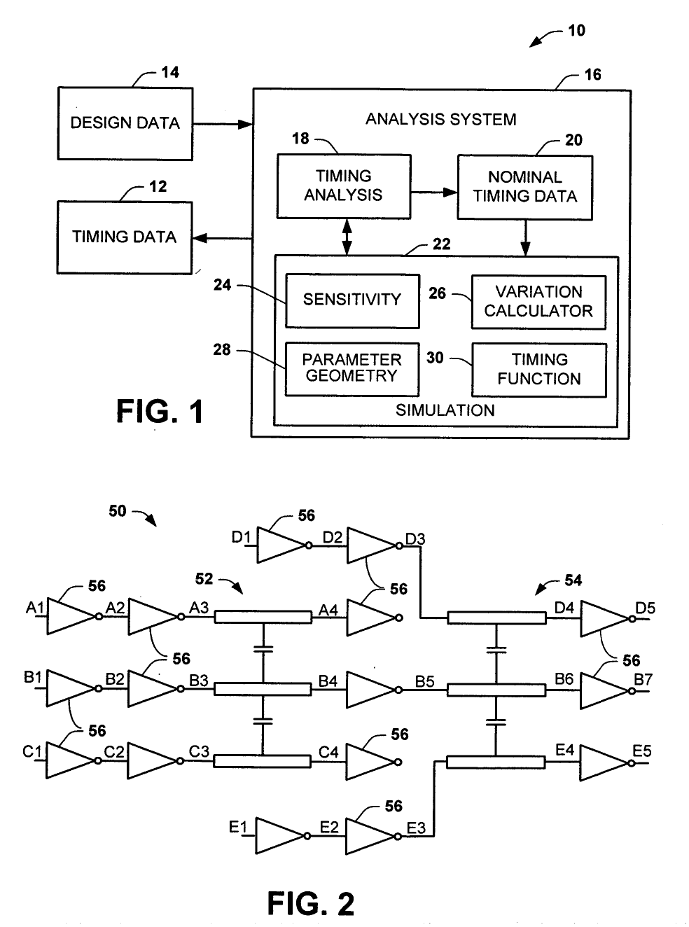

FIG. 2 depicts an example of a circuit 50 having two coupled interconnects 52 and 54. The circuit 50 includes a plurality of gates 56 that can be arranged to implement desired functions along respective paths. While the gates 56 are illustrated as inverters, those skilled in the art will understand that other types of gates having one or more inputs will typically be implemented in the circuit 50. As described herein, a given path can be defined in terms of a beginning node and an end node, which nodes are identified by letters (indicating a respective path) followed by numerical designations (indicating node location along a given path), as shown in FIG. 2. For example, a path from node B1 to node B7 corresponds to a path B, which propagates a signal through each of the two coupled interconnects 52 and 54.

A circuit unit containing the coupled interconnect 52, such as between nodes B3 and B4 or between B1 and B7, can vary in a variety of ways in terms of the number of aggressors, the amount of coupling associated with each aggressor, the type of the logic gate driving each aggressor and the victim, and the driving strength of those driving gates. Prior approaches have attempted to account for the effects of coupling at coupled interconnects by employing a Miller Coupling Factor (MCF). The MCF is a value that is assigned to a coupled interconnect based on switching characteristics of aggressors and the effect of such switching on the speed of transmission through the victim. The accuracy of the MCF and other current approaches inadequately models or oversimplifies the possible coupling effects between aggressors and victims, which can lead to reduced performance or even failure. Additionally, the MCF approach fails to consider variations in the delay.

The sensitivity based approach described herein treats each coupled interconnect unit on a case-by-case basis and provides a statistical timing variation (a standard deviation) for a coupled interconnect based on sensitivities between aggressors and victims. Without considering the variation of wires themselves, the source of delay variations of a coupled interconnect 52, 54 stems from two main areas: (1) variations of relative signal arrival times between aggressors and the victim; and (2) the variations of transistor parameters, such as transistor geometry (e.g., effective channel length (Le)) or other parameters of aggressors' driving gates. The delay variation of the coupled interconnect can, in turn, be parameterized as a statistical distribution having a standard deviation that is functionally related to the sensitivity of a coupled interconnect relative to the variations of (1) and (2).

As described herein, due to delay variations at gates, the arrival times of signals on the coupled interconnects 52 and 54 on a chip exhibit substantially random behavior, which can be modeled as statistical variables having a mean and standard deviation. Additionally, since the delay variation through a coupled interconnect 52, 54 is tightly coupled with the delay variation through the driving logic gates at nodes A3, B3 and C3, the coupled interconnect 52, including all the aggressors and their associated driving gates 56, can be aggregated as a single unit in terms of the associated delay variations. That is, the delay variation through the coupled interconnect 52 at B4 in path B varies as a function of the arrival times of aggressors' input signals at nodes A3 and C3. The arrival times at A3 and C3 further varies as a function of the arrival times at A2 and C2 corresponding to inputs of the respective gates 56 that drive the aggressors. The delay variation through the coupled interconnect 52 also varies as a function of delay variations through the gates 56 driving aggressors at nodes A3 and C3. The delay variations through the driving gates can be modeled as a dominant parameter of the driving gates 56, such as corresponding to the channel length (Le) of the transistors that drive the nodes A3 and C3.

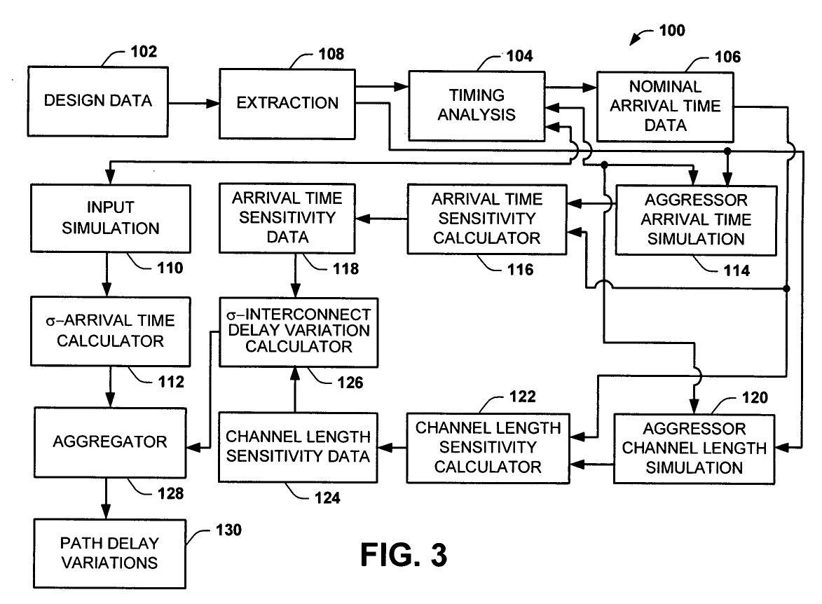

FIG. 3 depicts an example of a system 100 that can be utilized to determine delay variations for a path that includes a coupled interconnect. For purposes of ease of explanation, the system 100 of FIG. 3 will be described with respect to, and will refer back to, the example circuit of FIG. 2, and more particularly with respect to determining the delay variations of the coupled interconnect 52. Thus, the system 100 employs design data 102 that characterizes the components of the circuitry for which timing analysis is desired, including circuit data for the circuit 50 of FIG. 2. For example, the length of both coupled interconnects 52 and 54 may be 800 μm long, and implemented as metal interconnects according to the P1262 or other process technology. The design data 102 for example, can characterize the individual components (e.g., transistors, such as NFETS and PFETS) and interconnections that form each of the respective gates of the circuit design. The design data 102 can be provided in any number of commercial or proprietary formats, such as described herein.

A timing analysis block 104 is operative to perform a timing analysis relative to the design data 102 and provide corresponding nominal timing data 106. An extraction block 108 can be employed to extract the interconnect unit from the design data to provide respective coupled interconnect subcircuits, which include the driving logic gates to the coupled interconnects 52 and 54 (FIG. 2). The extraction block 108 provides the design data for the extracted interconnect units to the timing analysis block 104, such as for performing static timing analysis. Alternatively, the timing analysis block 104 can be programmed to perform the extraction. From the example of FIG. 2, the driving gates for the coupled interconnect 52 include the gates between A2 and A3, B2 and B3, and C2 and C3, as well as the interconnect between C3 and C4. Thus, as mentioned above, the respective interconnect units can include the gates 56 driving aggressors and the victim for the coupled interconnect.

The timing analysis block 104 performs timing analysis with respect to the extracted design data 102 to provide the nominal timing data 106. The timing analysis block 104 can be implemented by employing any standard or proprietary static timing analysis tool, such as, for example, PATHMILL® by Synopsys, SPICE, or another timing analysis tool. The nominal timing data 106 includes arrival times for nodes distributed in the interconnect unit, including upstream logic gates associated with the coupled interconnect 52. The arrival time information in the nominal timing data 106, however, does not take into account the effects of the coupled interconnect.

An input simulation block 10 can also be utilized in conjunction with the timing analysis block 104 to perform statistical analysis with respect to the input arrival times at the nodes of the interconnect unit. The statistical analysis can obtain a statistical distribution of actual input arrival times at the respective nodes by varying parameters in the circuit, including by varying the arrival times at the respective inputs of the upstream logic gates. The simulation block 110 provides simulation results to a σ-arrival time calculator 112. The σ-arrival time calculator 12 employs the statistical distribution associated with the input arrival times at each node to calculate a standard deviation (σ_{node}) for the arrival time at each node, which characterizes the statistical variations in arrival time for each node.

Additionally, the simulation block 10 and σ-arrival time calculator 112 can be employed to determine input-to-input arrival time variations for the gates in the interconnect unit having more than one input. The input-to-input arrival time variations thus characterize a relative arrival time variation at the inputs of the respective gates in the circuit design. The input-to-input arrival time standard deviation for a given gate victim thus is functionally related to the root-mean-square of individual arrival time variations for the given gate. For example, the input-to-input arrival time standard deviation can be expressed as follows:
σᵣₑₗ=\sqrt{σ₁²+ . . . σₙ²} Eq. 1

where σₙ=the standard deviation for arrival time at the n^{th} input of the respective gate.

The system 100 also includes an aggressor arrival time simulation block 114 that is operative to perform simulations to obtain a victim's delay sensitivity φᵢ with respect to aggressor arrival times, where i is a positive integer that identifies which aggressor the sensitivity is associated with. The aggressor arrival time simulation block 114 performs additional simulation in conjunction with the timing analysis block to determine the victim's delay sensitivity φᵢ according to the extracted coupled interconnect subcircuit data.

An arrival time sensitivity calculator 116 determines the victim's delay sensitivity φᵢ based on the simulation results and the nominal arrival times indicated by the nominal arrival time data 106. The arrival time calculator 116 provides corresponding arrival time sensitivity data 118 for characterizing victim delay sensitivity with respect to variation in signal arrival time for each respective aggressor based on the sensitivity calculations. The sensitivity φᵢ can be represented as a function of the change in the delay at the victim's output relative to the change in the arrival time at the aggressor. For example, the arrival time sensitivity calculator 116 can calculate the victim's delay sensitivity with respect to the aggressor as follows:

$${ϕ}_{i} = \frac{Δ {delay}_{( victim )}}{Δ arrival {time}_{( aggressor )}} \qquad Eq . 2$$

where

Δdelay_{(victim)}=delayₙₒₘᵢₙₐₗ−delay_{mod};

delayₙₒₘᵢₙₐₗ=delay from the nominal timing data 106;

delay_{mod}=a modified victim delay for the victim when the aggressor arrival time was incrementally modified by the simulation block 108;

Δarrival time_{(aggressor)}=arrivaltimeₙₒₘᵢₙₐₗ−arrivaltime_{mod}

arrivaltimeₙₒₘᵢₙₐₗ=actual nominal arrival time

arrivaltime_{mod}=modified aggressor arrival time.

By way of further example, the sensitivity can be determined by implementing a finite difference analysis according to Eq. 2. The analysis can be repeated to obtain a sensitivity for a coupled interconnect with respect to each aggressor by incrementally varying the input arrival times of the driving gates of the respective aggressors. For instance, the sensitivities can be determined for each respective aggressor while the other aggressors to the interconnect unit are held at a static or a steady state during the simulation. This is because the delay variation for the coupled interconnect attributable to each aggressor, based on the sensitivity φᵢ, can be aggregated to provide a complete aggregate indication of the delay variation, as described herein (see, e.g., Eq. 4).

The system 100 also includes also includes an aggressor channel length simulation block 120. The channel length simulation block 120 is operative to perform simulations for determining a victim's delay sensitivity ξⱼ with respect to transistor channel length variations of the drivers associated with the coupled interconnect 52. The channel length simulation block 120 performs the simulations based on the nominal arrival time data 106 and the extracted coupled interconnect subcircuit data provided by the extraction block 108.

The simulation block 120 can perform the simulations for each transistor that is connected to drive the coupled interconnect, such as those transistors driving nodes A3, B3, and C3, which are associated with the interconnect 52. The simulation block 120 performs simulations for each transistor of the respective drivers 56 by varying the transistor channel length (Le) or other parameter of the transistor that may result in delay variations at the coupled interconnect. Those skilled in the art will understand and appreciate that other physical parameters in addition or as an alternative to channel length can be utilized. Since Le generally will be the dominant parameter for imposing delay variations through a gate, however, other parameters can be excluded from the simulations and still provide a high degree of accuracy. The simulations can also obtain a statistical distribution of the Le parameter for each respective transistor to provide a corresponding standard deviation for Le (σ_{Le}).

A channel length sensitivity calculator 122 employs the simulation results from the simulation block 120 to determine the victim's delay sensitivity ξⱼ with respect to channel length based on the nominal arrival times indicated by the nominal arrival time data 106. The channel length sensitivity calculator 122 provides corresponding victim delay sensitivity data 124 for each respective transistor driving an aggressor based on the sensitivity calculations. The sensitivity ξⱼ can be represented as a function of the change in the delay at the victim's output relative to the change in the transistor channel length. For example, the channel length sensitivity calculator 122 can calculate the victim's delay sensitivity with respect to Le for each transistor as follows:

$${ξ}_{j} = \frac{Δ delay}{Δ {Le}_{j}} \qquad Eq .3$$

where

Δdelay_{(victim)}=delayₙₒₘᵢₙₐₗ−delay_{mod};

delayₙₒₘᵢₙₐₗ=delay from the nominal timing data 106;

delay_{mod}=a modified victim delay for the victim when the aggressor arrival time was incrementally modified by the simulation block 114;

ΔLeⱼ=Leₙₒₘᵢₙₐₗ−Le_{mod}

Leₙₒₘᵢₙₐₗ=actual nominal Le (from design data);

Le_{mod}=modified Le from simulation.

The channel length sensitivity calculator 122 thus can compute the delay sensitivity ξⱼ with respect to each transistor of the driving gates of the coupled interconnect by performing a finite difference analysis according to Eq. 3. The calculator 122 provides the result of the calculations as delay sensitivity data 124. The simulations and sensitivity calculations based thereon can be performed one transistor at a time while the rest of the transistors that are driving the couple interconnect are set to their nominal channel lengths.

A σ-interconnect delay variation calculator 126 determines a standard deviation of the coupled interconnect delay based on the delay sensitivity data 118 for arrival time and the delay sensitivity data 124 for channel length. The calculator 126 can compute the standard deviation for the coupled interconnect as the root-mean-square of the sums of independent standard deviation values associated with the respective sensitivities. For example, the standard deviation for the delay variation of the coupled interconnect σ_{INT} can be expressed as follows:

$${σ}_{INT} = \sqrt{{\sum }_{i} {( {ϕ}_{i} {σ}_{i} )}^{2} + {\sum }_{j} {( {ξ}_{j} {σ}_{j} )}^{2}} . \qquad Eq . 4$$

where

φᵢ=victim delay sensitivity with respect to signal arrival time at a given aggressor i (from Eq. 2), i denoting a given one of the aggressors;

σᵢ=standard deviation of delay for the given aggressor i;

ξⱼ=victim delay sensitivity with respect to a physical parameter (e.g., Le) variations in a given transistor j that drives a respective one of the aggressors (from Eq. 3), j denoting a given one of the transistors; and

σⱼ=standard deviation of delay for a given transistor j.

An aggregator 128 can be provided to aggregate the respective standard deviations values provided by the σ-arrival time calculator 112 and the a-interconnect delay variation calculator 126. The aggregator thus can employ the aggregated data to provide path delay variations 130, which characterizes delay variations for a path (path B from FIG. 2), that includes one or more coupled interconnects 52, 54. For example, the aggregator 128 can calculate the path delay variations as the root-mean-square of the respective arrival time standard deviations computed by the σ-arrival time calculator 112 (for gates having both one input, σ_{node}, and multiple inputs, σᵣₑₗ) and the standard deviation computed by the a-interconnect delay variation calculator 126, namely σ_{INT}.

Thus, the model and approach utilized by the system 100 is operative to reduce the path failures by providing more accurate timing windows than many conventional approaches such as the MCF approach. Additionally, the approach implemented by the system 100 allows designers to determine the magnitude and direction of the effect of each aggressor on the victim and thereby allow more productive concentration of design effort to achieve desired timing values. Moreover, the approach implemented by the system 100 allows the designer to determine the effect of introducing circuits of differing variability on the interconnect without needing to re-simulate to fine sensitivity numbers.

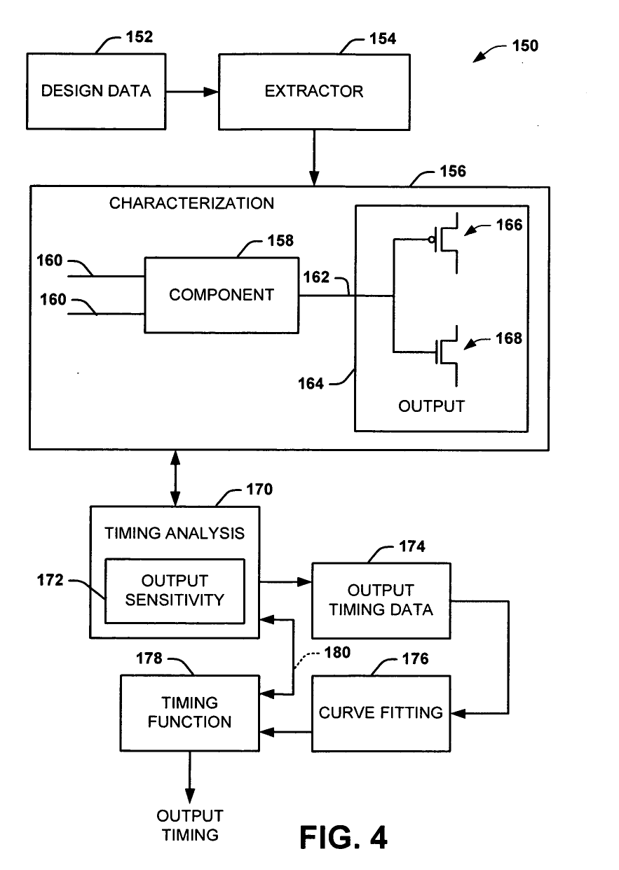

FIG. 4 illustrates a system 150 depicting another sensitivity based approach for timing analysis. The system 150 is operative to provide sensitivity based timing information for a node of a component, which can be described in design data 152 for a circuit, such as described herein. An extractor 154 extracts pertinent information from the design data 152 to provide a characterization 156 that includes a representation of the component, indicated at 158. The component 158, for example, can correspond to a library cell, which can be from a predetermined library system or a custom cell. The component 158 can include one or more inputs 160, at which respective input signals can be provided. An output node 162 of the component 158 feeds or fans-out to an output system 164.

The extractor 154 can characterize the output system 164 of the component 158 as a combination of transistors 166 and 168. For example, the transistor 166 can be implemented as a PFET and the transistor 168 can be implemented as an NFET. Each of the transistors 166 and 168 in the characterization 156 can have one or more parameters that can be programmed with values to approximate an actual fan out for the component 158 based on the circuit design described by the design data 152. The transistor parameters can include width, Le, VT, or other physical parameters that might affect delay variations in the output timing at the output node 162 for signals propagating through the component 158. The appropriate parameters may vary according to process variations utilized to fabricate the circuit that includes the design.

For purposes of the following example, it is assumed that transistor width is a dominant parameter for the output transistors 166 and 168, such that other transistor parameters for the transistors can be set to their nominal values according to the design data 152. The width of the NFET and PFET components 166 and 168 in the characterization thus approximates a summation of respective widths of the NFET and PFET devices that are connected at the output node 162 of the circuit design described by the design data 152.

The system 150 employs a timing analysis block 170 to perform timing analysis relative to the characterization 156. The timing analysis block 170 includes an output sensitivity component 172 that is operative to modify incrementally the variable parameters (e.g., transistor widths) of the respective transistors 166 and 168 in the characterization 156. The timing analysis block 170 provides timing data 174 by performing static timing analysis.

For example, the output variation block can perform a multi-dimensional sweep by incrementally and independently varying the respective widths of the PFET 166 and the NFET 168 in the output system 164 of the characterization 156. The timing analysis block 170 thus provides corresponding output timing data 174 for each incremental variation in the widths. The output timing data 174 thus characterizes a sensitivity in the output timing at the node 162 relative to variations in the output system, namely transistor width. Those skilled in the art will understand and appreciate that, by the output sensitivity component 172 employing smaller incremental changes for the widths of the respective transistors 166 and 168 in the output characterizations 156, a more extensive distribution of output timing data 174 and more accurate indication of output sensitivity can be obtained for the component 158.

A curve fitting function 176 employs the output timing data 174 to determine a timing function 178 for the component 158. The output timing data 174 provides multi-dimensional data as a function of FET geometry (e.g., PFET width and NFET width) that is coupled to the output node 162 of the component 158. The curve fitting function 176, for example, can employ any number of techniques, such as polynomial regression, implemented using standard tools to provide the timing function 178. Examples of suitable software tools include non-linear curve fitting functions implemented in MATLAB® software, which is available from Mathworks, Inc. Those skilled in the art will appreciate other techniques and tools that could be utilized to derive the timing function 178 based on the timing data 174. The timing function 178 thus provides a non-linear characterization for the component 158 according to the sensitivity of the component relative to variation in width of the respective NFET and PFET components 166 and 168 at the output of the component 158. Those skilled in the art will understand and appreciate that the sensitivity of the output timing determined for the node 162 can also be combined with standard delay characteristics associated with the component 158 itself, which can be determined from the timing analysis that is run for a given design.

An example of timing data as function of total NFET and PFET width is illustrated in the following table.

| | | Output Node |
|---|---|---|
| Σ NFET width(μm) | Σ PFET width(μm) | Timing(ps) |
| 1 | 1 | 10 |
| 1 | 2 | 15 |
| 1 | 3 | 22 |
| 2 | 1 | 14 |
| 2 | 2 | 20 |
| 2 | 3 | 26 |
| 3 | 1 | 21 |
| 3 | 2 | 28 |
| 3 | 3 | 40 |

For the simplified example in the above table, the curve fitting function 176 can characterize the output timing sensitivity for the component 158 for the component nonlinearly to provide the timing function 158 as a corresponding polynomial function. The corresponding polynomial function for the output timing of the component (e.g., a library cell) 158 can be determined by a polynomial fit of output timing data, such as from the foregoing table. By way of further example, the output timing function 178 can be approximated as follows:
Output Timing(PW, NW)=13.22−7.16*NW−1.0*PW+2.66*NW*NW+1.16*PW*PW+1.75*NW*PW Eq. 5

where:

PW=ΣPFET width (in μm) for the set of PFET devices attached to the output of the cell; and

NW=ΣNFET width (in μm) for the set of NFET devices attached at the output node of the cell.

The timing function 178 may be employed in subsequent timing analysis 170, as indicated by the dashed line 180, to implement a sensitivity based timing analysis. For example, during timing analysis of nodes in a VLSI design, if a previously characterized library cell is encountered, the total PFET width and NFET width at the output of the cell can be determined by employing the corresponding timing function 178 to ascertain the output timing thereof. Alternatively, when a new cell is encountered during analysis, the system 150 can be utilized to characterize the cell and, in turn, generate the corresponding timing function that can then be utilized to provide output timing for a component or cell, as described herein.

Those skilled in the art will understand and appreciate that the timing function 178 can also be utilized in a statistical timing analysis, such as a Monte Carlo analysis, for generating a statistical distribution for the output timing data for one or more components in a given VLSI design. A corresponding standard deviation for the output timing (corresponding to output timing variations) thus can be derived from the distribution. When evaluating a path in the VLSI design, a root-mean-square can be performed on the respective arrival time variations, output timing variations, and coupled interconnect delay variations (all being standard deviations) to provide an aggregate indication of delay variation for the respective path.

Those skilled in the art will further understand and appreciate that the approach described above with respect to FIG. 4 establishes a relationship between gate geometry and its corresponding gate capacitance without assuming any underlying behavior of gate capacitance, as is performed in many traditional approaches for timing analysis. Furthermore, the approach described herein directly associates the driving gate delay with its loading transistor geometries in a polynomial or non-linear relationship, which provides improved accuracies over existing linear approximation approaches. Additionally, from the system 150, the polynomial relationship expressed in the timing function 178 can improve the accuracy for statistical timing analysis since translation between loading transistor geometry and a corresponding approximation of gate capacitance is not required.

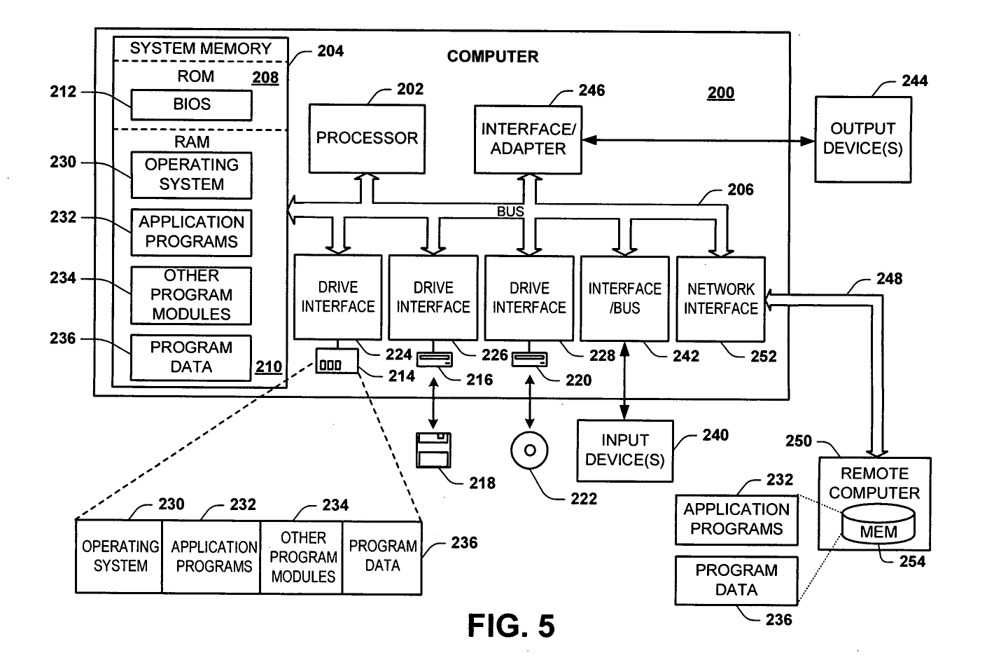

FIG. 5 illustrates a computer system 200 that can be employed to implement systems and methods described herein, such as based on computer executable instructions running on the computer system. The computer system 200 can be implemented on one or more general purpose networked computer systems, embedded computer systems, routers, switches, server devices, client devices, various intermediate devices/nodes and/or stand alone computer systems. Additionally, the computer system 200 can be implemented as part of the computer-aided engineering (CAE) tool running computer executable instructions to perform a method as described herein.

The computer system 200 includes a processor 202 and a system memory 204. A system bus 206 couples various system components, including the system memory 204 to the processor 202. Dual microprocessors and other multi-processor architectures can also be utilized as the processor 202. The system bus 206 can be implemented as any of several types of bus structures, including a memory bus or memory controller, a peripheral bus, and a local bus using any of a variety of bus architectures. The system memory 204 includes read only memory (ROM) 208 and random access memory (RAM) 210. A basic input/output system (BIOS) 212 can reside in the ROM 208, generally containing the basic routines that help to transfer information between elements within the computer system 200, such as a reset or power-up.

The computer system 200 can include a hard disk drive 214, a magnetic disk drive 216, e.g., to read from or write to a removable disk 218, and an optical disk drive 220, e.g., for reading a CD-ROM or DVD disk 222 or to read from or write to other optical media. The hard disk drive 214, magnetic disk drive 216, and optical disk drive 220 are connected to the system bus 206 by a hard disk drive interface 224, a magnetic disk drive interface 226, and an optical drive interface 234, respectively. The drives and their associated computer-readable media provide nonvolatile storage of data, data structures, and computer-executable instructions for the computer system 200. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital video disks and the like. A number of program modules may also be stored in one or more of the drives as well as in the RAM 210, including an operating system 230, one or more application programs 232, other program modules 234, and program data 236.

A user may enter commands and information into the computer system 200 through user input device 240, such as a keyboard, a pointing device (e.g., a mouse). Other input devices may include a microphone, a joystick, a game pad, a scanner, a touch screen, or the like. These and other input devices are often connected to the processor 202 through a corresponding interface or bus 242 that is coupled to the system bus 206. Such input devices can alternatively be connected to the system bus 206 by other interfaces, such as a parallel port, a serial port or a universal serial bus (USB). One or more out device(s) 244, such as a visual display device or printer, can also be connected to the system bus 206 via an interface or adapter 246.

The computer system 200 may operate in a networked environment using logical connections 248 to one or more remote computers 250. The remote computer 248 may be a workstation, a computer system, a router, a peer device or other common network node, and typically includes many or all of the elements described relative to the computer system 200. The logical connections 248 can include a local area network (LAN) and a wide area network (WAN).

When used in a LAN networking environment, the computer system 200 can be connected to a local network through a network interface 252. When used in a WAN networking environment, the computer system 200 can include a modem (not shown), or can be connected to a communications server via a LAN. In a networked environment, application programs 232 and program data 236 depicted relative to the computer system 200, or portions thereof, may be stored in memory 254 of the remote computer 250.

By way of further example, one or more application program (running on the computer 200 or the remote computer 250) can include executable instructions for determining sensitivity based timing information for a portion of a circuit design, such as a component or a path comprising a plurality of components. Examples of various feature of that can be implemented as executable instructions for are shown and described herein with respect to FIGS. 1-4 and 6. Those skilled in the art will understand and appreciate various approaches that can be utilized to program the computer system 200 based on the teachings contained herein.

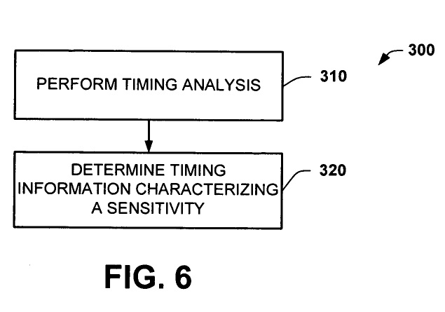

In view of the foregoing structural and functional features described above, certain methods will be better appreciated with reference to FIG. 6. It is to be understood and appreciated that the illustrated actions, in other embodiments, may occur in different orders and/or concurrently with other actions. Moreover, not all illustrated features may be required to implement a method. It is to be further understood that the following methodologies can be implemented in hardware (e.g., a computer or a computer network), software (e.g., as executable instructions running on one or more computer systems), or any combination of hardware and software.

FIG. 6 depicts a method 300. The method 300 may include performing timing analysis for at least a portion of a circuit design, as shown at 310. The method 300 may include determining timing information, based on the performed timing analysis, for a node associated with a first component of the at least a portion of the circuit design relative to variations in a parameter associated with at least one second component of the at least a portion of the circuit design, as shown at 310. The timing information for the node associated with the first component characterizes a sensitivity of the first component relative to the variations in the parameter associated with the at least one second component.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A system comprising:
design data that describes at least a portion of a circuit design; and
an analysis system that determines timing information for a node associated with a first component of the circuit design relative to variations in a parameter associated with at least one second component of the circuit design, the timing information for the node associated with the first component characterizing a sensitivity of the first component relative to the variations in the parameter associated with the at least one second component.

2. The system of claim 1, wherein the first component comprises one of a coupled interconnect and a predetermined library cell.

3. The system of claim 1, wherein the first component comprises a coupled interconnect, the analysis system further comprising:
a simulator that determines a delay sensitivity associated with a victim of the coupled interconnect based on delay timing information for the victim of the coupled interconnect relative to variation in a corresponding statistical parameter that affects timing at the victim of the coupled interconnect; and
a variation calculator that determines the timing information as a statistical parameter indicative of delay variation for the coupled interconnect based on the delay sensitivity.

4. The system of claim 3, wherein the delay sensitivity further comprises a first delay sensitivity with respect to a signal arrival time at a plurality of aggressors to the victim of the coupled interconnect, the corresponding statistical parameter further comprising a corresponding standard deviation of the signal arrival time for each respective one of the plurality of aggressors.

5. The system of claim 4, wherein the delay sensitivity further comprises a second delay sensitivity with respect to variation in a physical parameter of transistors that drive the respective plurality of aggressors, the corresponding statistical parameter further comprising a corresponding standard deviation of the physical parameter of each respective transistor.

6. The system of claim 5, wherein the physical parameter comprises channel length of each respective transistor.

7. The system of claim 5, wherein the variation calculator determines the statistical parameter indicative of delay variation for the coupled interconnect as a standard deviation of delay variation for the coupled interconnect, the standard deviation of delay variation for the coupled interconnect being determined as a function of (1) the first delay sensitivity for each aggressor and the corresponding standard deviation of the signal arrival time for each respective one of the plurality of aggressors, and (2) the second delay sensitivity for each transistor that drives the respective aggressors and the corresponding standard deviation of the physical parameter of each respective transistor.

8. The system of claim 5, wherein the variation calculator determines the statistical parameter indicative of delay variation for the coupled interconnect as a standard deviation (σ_{INT}) of delay variation for the coupled interconnect that is defined as:
$${σ}_{INT} = \sqrt{{\sum }_{i} {( {ϕ}_{i} {σ}_{i} )}^{2} + {\sum }_{j} {( {ξ}_{j} {σ}_{j} )}^{2}}$$
where:
φᵢ=the delay sensitivity with respect to the signal arrival time at each of the plurality of aggressors, and i denotes a given one of the plurality of aggressors;
σⱼ=a standard deviation of the signal arrival time for the given one of the plurality of aggressors;
ξⱼ=the delay sensitivity with respect to the variations in the physical parameter of each transistor that drives the plurality of aggressors, and j denotes a given one of the transistors; and
σⱼ=a standard deviation in the physical parameter for the given one of the transistors.

9. The system of claim 3, further comprising
an extractor that extracts an interconnect unit based on the design data of the circuit design to characterize the first component and the at least one second component, the at least one second component comprising associated components located upstream relative to at least some of the aggressors; and
a timing analysis system operative to provide nominal timing information for nodes of the interconnect unit, the simulator employing the nominal timing data to determine the delay sensitivity.

10. The system of claim 1, wherein the analysis system further comprises an input arrival time calculator that determines a statistical indication of delay variation for each of a plurality of components in the circuit design that includes one or more inputs based on a statistical indication of arrival time variations for each signal at the one or more inputs thereof.

11. The system of claim 1, wherein the design data comprises a characterization of the first component as being connected to drive the at least one second component, the at least one second component defining an output system, the analysis system further comprising a simulation system that varies at least two parameters of the output system and performs timing analysis on the characterization to generate timing data associated with an output of the first component, a sensitivity function being generated based on the timing data so as to non-linearly characterize the output timing characteristics of the first component according to variations in the at least two parameters of the output system.

12. The system of claim 11, further comprising an extractor that extracts selected circuit information from the design data to generate the characterization of the first component.

13. The system of claim 11, wherein the first component comprises a library cell.

14. The system of claim 11, wherein the output system further comprises:
an N-type field effect transistor having a gate coupled to the output of the first component, a first of the at least two parameters corresponding to at least one physical parameter of the N-type field effect transistor; and
a P-type field effect transistor having a gate coupled to the output of the first component, a second of the at least two parameters corresponding to at least one physical parameter of the P-type field effect transistor.

15. The system of claim 14, wherein the first of the at least two parameters comprises a width of the N-type field effect transistor and the second of the at least two parameters comprises a width of the P-type field effect transistor.

16. The system of claim 11, further comprising a curve fitting function that generates the timing function based on the timing data.

17. The system of claim 16, wherein the curve fitting function generates the sensitivity function as a polynomial that varies as a function of the at least two parameters.

18. The system of claim 11, further comprising a timing analysis system that employs the sensitivity function, in response to encountering a corresponding instance of the component in the circuit design, to determine output timing information for the corresponding instance of the component.

19. The timing analysis system of claim 18, further comprising a plurality of the sensitivity functions, each of the plurality of sensitivity functions non-linearly characterizing output timing characteristics for a given circuit component as a function of the at least two parameters associated with an output system that is coupled to an output of the given circuit component in the circuit design.

20. The system of claim 11, wherein the first component further comprises a coupled interconnect;
the simulation system determining a delay sensitivity associated with a victim of the coupled interconnect based on delay timing information for the victim of the coupled interconnect relative to variation in a corresponding statistical parameter that affects timing at the victim of the coupled interconnect; and
the analysis system further comprising a variation calculator that determines the timing information as a statistical parameter indicative of delay variation for the coupled interconnect based on the delay sensitivity.

21. The system of claim 20, wherein the analysis system further comprises an input arrival time calculator that determines a statistical indication of delay variation for each of a plurality of components in the circuit design that includes one or more inputs based on a statistical indication of arrival time variations for each signal at the one or more inputs thereof.

22. A system comprising:
a simulator that determines a delay sensitivity associated with a victim of a coupled interconnect based on delay timing information for the victim of the coupled interconnect relative to at least one corresponding variation in a parameter that affects timing at the victim of the coupled interconnect; and
a variation calculator that determines a statistical indication of delay variation for the coupled interconnect based on the delay sensitivity and a corresponding statistical parameter.

23. The system of claim 22, wherein the corresponding statistical parameter further comprises at least one of (i) a standard deviation of signal arrival time at aggressors to the victim of the coupled interconnect, and (ii) a standard deviation of a physical parameter associated with drivers of the aggressors to the victim of the coupled interconnect.

24. The system of claim 22, wherein the delay sensitivity further comprises a delay sensitivity with respect to a signal arrival time for each aggressor to the victim of the coupled interconnect, the corresponding statistical parameter further comprising a corresponding standard deviation of the signal arrival time for each respective aggressor.

25. The system of claim 22, wherein the delay sensitivity further comprises a delay sensitivity with respect to variation in a physical parameter of each component coupled to drive each aggressor to the victim of the coupled interconnect, the corresponding statistical parameter further comprising a corresponding standard deviation of the physical parameter.

26. The system of claim 22, further comprising
an extractor that extracts an interconnect unit from a circuit design that characterizes the coupled interconnect and associated components located upstream relative to aggressors to the victim of the coupled interconnect; and
an arrival time calculator that determines a respective statistical indication of variation in signal arrival time for the associated components in the interconnect unit.

27. The system of claim 26, further comprising an input-to-input arrival time calculator that determines a relative statistical indication of variation in signal arrival time for each of the associated components in the interconnect unit having a plurality of inputs based on a statistical parameter indicating arrival time variations for respective signals at the plurality of inputs thereof.

28. The system of claim 27, the input-to-input arrival time calculator determines the relative statistical indication of variation in signal arrival time for each of the associated components as a standard deviation σᵣₑₗ that is defined as:
σᵣₑₗ=\sqrt{σ₁²+ . . . σₙ²}
where σₙ=the standard deviation for arrival time at the n^{th} input of the given one of the associated components, and n is a positive integer denoting the number of inputs for the given one of the associated components.

29. The system of claim 22, further comprising a plurality of aggressor drivers, each being connected for driving a respective aggressor that is associated with the coupled interconnect, each of the plurality of aggressor drivers having at least one input, the simulator determining a first delay sensitivity of the victim with respect to signal arrival time at the at least one input of each of the plurality of aggressors.

30. The system of claim 29, wherein the variation calculator determines a statistical indication of delay variation for the coupled interconnect based on the first delay sensitivity determined for each of the plurality of aggressors and based on a corresponding statistical parameter indicative of variation in signal arrival time for each respective one of the plurality of aggressors.

31. The system of claim 30, wherein the delay sensitivity further comprises a second delay sensitivity with respect to variation in a physical parameter of each of a plurality of aggressor drivers that drive the respective aggressors, wherein the variation calculator further determines a statistical indication of delay variation for the coupled interconnect based on the second delay sensitivity determined for each of the plurality of aggressor drivers and based on a corresponding statistical parameter indicative of variation in the physical parameter time for each respective one of the plurality of aggressor drivers.

32. The system of claim 31, wherein the aggressor drivers comprise corresponding transistors and the physical parameter further comprises a channel length of the corresponding transistors.

33. The system of claim 31, wherein the statistical indication of delay variation for the coupled interconnect comprises a standard deviation (σ_{INT}) of the delay variation for the coupled interconnect that is defined as:
$${σ}_{INT} = \sqrt{{\sum }_{i} {( {ϕ}_{i} {σ}_{i} )}^{2} + {\sum }_{j} {( {ξ}_{j} {σ}_{j} )}^{2}}$$
where:
φᵢ=the delay sensitivity with respect to the signal arrival time at each of the plurality of aggressors, and i denotes a given one of the plurality of aggressors;
σᵢ=a standard deviation of the signal arrival time for the given one of the plurality of aggressors;
ξⱼ=the delay sensitivity with respect to the variations in the physical parameter of each transistor that drives the plurality of aggressors, and j denotes a given one of the transistors; and
σⱼ=a standard deviation in the physical parameter for the given one of the transistors.

34. The system of claim 30, wherein the first delay sensitivity further comprises delay sensitivity with respect to a difference between a nominal arrival time at at least one input of each of the plurality of aggressors relative to a shifted arrival time at the at least one input of each of the plurality of aggressors.

35. The system of claim 34, wherein the delay sensitivity further comprises delay sensitivity with respect to a physical parameter of a transistor that forms the at least one aggressor driver.

36. An analysis system comprising:
a first sensitivity calculator that determines a first delay sensitivity for a victim of a coupled interconnect with respect to variation in a signal arrival time at each of a plurality of aggressors to the victim of the coupled interconnect;
a second sensitivity calculator that determines a second delay sensitivity with respect to variation in a physical parameter of components that drive the respective aggressors; and
a variation calculator that determines a statistical indication of delay variation for the coupled interconnect based on the first delay sensitivity and a first corresponding statistical parameter and based on the second delay sensitivity and a second corresponding statistical parameter.

37. The system of claim 36, wherein the first corresponding statistical parameter further comprises a standard deviation of the signal arrival time for each respective one of the plurality of aggressors to the victim, and the second corresponding statistical parameter comprises a standard deviation of the physical parameter associated with each of a plurality of transistors coupled to drive the plurality of aggressors to the victim of the coupled interconnect.

38. The system of claim 36, wherein the variation calculator determines the statistical parameter indicative of delay variation for the coupled interconnect as a standard deviation (σ_{INT}) of the delay variation for the coupled interconnect that is defined as:
$${σ}_{INT} = \sqrt{{\sum }_{i} {( {ϕ}_{i} {σ}_{i} )}^{2} + {\sum }_{j} {( {ξ}_{j} {σ}_{j} )}^{2}}$$
where:
φᵢ=the delay sensitivity with respect to the signal arrival time at each of the plurality of aggressors, and i denotes a given one of the plurality of aggressors;
σᵢ=a standard deviation of the signal arrival time for the given one of the plurality of aggressors;
ξⱼ=the delay sensitivity with respect to the variations in the physical parameter of each transistor that drives the plurality of aggressors, and j denotes a given one of the transistors; and
σⱼ=a standard deviation in the physical parameter for the given one of the transistors.

39. The system of claim 36, further comprising an input-to-input arrival time calculator that determines a relative statistical indication of variation in signal arrival time for each associated component of an interconnect unit having a plurality of inputs based on a statistical parameter indicating arrival time variations for respective signals at the plurality of inputs thereof, the interconnect unit characterizing the coupled interconnect and associated components located upstream relative to the plurality of aggressors.

40. A system comprising:
means for determining a first delay sensitivity for a victim of a coupled interconnect with respect to each of a plurality of aggressors to the victim of the coupled interconnect;
means for determining a second delay sensitivity with respect to associated components that drive the respective aggressors; and
means for calculating a statistical indication of delay variation for the coupled interconnect as a function of the first delay sensitivity and a first corresponding statistical parameter and as a function of the second delay sensitivity and a second corresponding statistical parameter.

41. The system of claim 40, wherein the first delay sensitivity further comprises a delay sensitivity with respect to a signal arrival time for each aggressor to the victim of the coupled interconnect, the corresponding statistical parameter further comprising a corresponding standard deviation of the signal arrival time for each respective aggressor.

42. The system of claim 40, wherein the second delay sensitivity further comprises a delay sensitivity with respect to variation in a physical parameter of each component coupled to drive each aggressor to the victim of the coupled interconnect, the corresponding statistical parameter further comprising a corresponding standard deviation of the physical parameter.

43. A system comprising:
a characterization of a component that is connected to drive an output system coupled to an output of the component; and
a simulation system that varies at least two parameters of the output system and performs timing analysis of the characterization to generate timing data for the output of the component, a timing function being generated based on the timing data to non-linearly characterize the output timing characteristics of the circuit component according to variations in the at least two parameters of the output system.

44. The system of claim 43, further comprising an extractor that extracts selected circuit information from design data to generate the characterization of the component.

45. The system of claim 43, wherein the component comprises a library cell.

46. The system of claim 43, wherein the output system further comprises:
an N-type field effect transistor, a first of the at least two parameters corresponding to at least one physical parameter of the N-type field effect transistor; and
a P-type field effect transistor, a second of the at least two parameters corresponding to at least one physical parameter of the P-type field effect transistor.

47. The system of claim 46, wherein the first parameter comprises a width of the N-type field effect transistor and the second parameter comprises a width of the P-type field effect transistor.

48. The system of claim 43, further comprising a curve fitting function that generates the timing function based on the timing data.

49. The system of claim 48, wherein the curve fitting function generates the timing function as a polynomial that varies as a function of the at least two parameters.

50. A timing analysis system in combination with the system of claim 43, wherein, in response to encountering a corresponding instance of the component in the circuit design, the timing analysis system employs the timing function to determine output timing information for the corresponding instance of the component.

51. The timing analysis system of claim 50, further comprising a plurality of the timing functions, each of the plurality of timing functions non-linearly characterizing output timing characteristics for a given circuit component as a function of the at least two parameters associated with an output system that is coupled to an output of the given circuit component.

52. A system comprising:
means for characterizing a component that is connected to drive an output system coupled to an output of the component;
means for varying at least two parameters of the output system and for performing timing analysis of the characterization to generate timing data for the output of the component; and
means for generating a timing function based on the timing data to non-linearly characterize the output timing characteristics of the circuit component according to variations in the at least two parameters of the output system.

53. A method comprising:
performing timing analysis for at least a portion of a circuit design; and
determining timing information, based on the performed timing analysis, for a node associated with a first component of the at least a portion of the circuit design relative to variations in a parameter associated with at least one second component of the at least a portion of the circuit design, the timing information for the node associated with the first component characterizing a sensitivity of the first component relative to the variations in the parameter associated with the at least one second component.

54. The method of claim 53, wherein the first component comprises a coupled interconnect of the circuit design, the determination of the timing information further comprising:
determining a delay sensitivity associated with a victim of the coupled interconnect based on delay timing information for the victim of the coupled interconnect relative to variation in a corresponding statistical parameter that affects timing at the victim of the coupled interconnect; and
calculating the timing information as a statistical parameter indicative of a delay variation for the coupled interconnect as a function of the delay sensitivity and the corresponding statistical parameter.

55. The method of claim 54, wherein the determination of the delay sensitivity further comprises at least one of:
calculating a first delay sensitivity as a function of variation in delay for the victim of the coupled interconnect relative to variation in a standard deviation of signal arrival time associated with each of a plurality of aggressors to the victim of the coupled interconnect; and
calculating a second delay sensitivity as a function of variation in delay for the victim of the coupled interconnect with respect to variation in a standard deviation of a physical parameter for transistors that drive each respective one of the plurality of aggressors.

56. The method of claim 54, wherein the calculation of the timing information further comprises:
calculating the statistical parameter indicative of delay variation for the coupled interconnect as a standard deviation (σ_{INT}) of the delay variation for the coupled interconnect that is defined as:
$${σ}_{INT} = \sqrt{{\sum }_{i} {( {ϕ}_{i} {σ}_{i} )}^{2} + {\sum }_{j} {( {ξ}_{j} {σ}_{j} )}^{2}}$$
where:
φᵢ=the delay sensitivity with respect to the signal arrival time at each of the plurality of aggressors, and i denotes a given one of the plurality of aggressors;
σᵢ=a standard deviation of the signal arrival time for the given one of the plurality of aggressors;
ξⱼ=the delay sensitivity with respect to the variations in the physical parameter of each transistor that drives the plurality of aggressors, and j denotes a given one of the transistors; and
σⱼ=a standard deviation in the physical parameter for the given one of the transistors.

57. A computer programmed to perform the method of claim 54.

58. The method of claim 53, further comprising extracting an interconnect unit from the circuit design to characterize the first component as a coupled interconnect and to characterize the at least one second component as including associated components located upstream relative to aggressors to the victim of the coupled interconnect.

59. The method of claim 58, further comprising calculating a statistical indication of delay variation for each of a plurality of components in the interconnect unit that includes one or more inputs based on a statistical indication of arrival time variations at the one or more inputs thereof.

60. The method of claim 53, further comprising:
characterizing the first component of the circuit design as being connected to drive the at least one second component;
characterizing the at least one second component as an output system;
performing timing analysis on the characterizations of the first component and the output system to provide timing data for an output of the first component that varies as a function of at least two parameters of the output system; and
generating a sensitivity function based on the timing data so as to non-linearly characterize output timing characteristics of the first component according to variations in the at least two parameters of the output system.

61. The method of claim 60, wherein the characterization of the output system further comprises:
characterizing a first part of the output system as an N-type field effect transistor, a first of the at least two parameters corresponding to at least one physical parameter of the N-type field effect transistor; and
characterizing a second part of the output system as a P-type field effect transistor, a second of the at least two parameters corresponding to at least one physical parameter of the P-type field effect transistor.

62. The method of claim 61, wherein the first parameter comprises a width of the N-type field effect transistor and the second parameter comprises a width of the P-type field effect transistor.

63. The method of claim 60, wherein the generation of the sensitivity function further comprises performing a polynomial fit on the timing data to generate the sensitivity function as a polynomial that varies as a function of the at least two parameters.

64. The method of claim 60, further comprising employing the sensitivity function in response to encountering a corresponding instance of the first component in the circuit design during timing analysis that is being performed to determine output timing information for the corresponding instance of the first component based on the at least two parameters associated with a corresponding output system being driven by the corresponding instance of the first component.

65. A computer programmed to perform the method of claim 60.

66. A computer readable article having computer executable instructions for:
simulating operation of at least a portion of a circuit design; and
calculating timing information for a node associated with a first component of the at least a portion of the circuit design relative to variations in a parameter associated with at least one second component of the at least a portion of the circuit design, the timing information for the node associated with the first component characterizing a sensitivity of the first component relative to the variations in the parameter associated with the at least one second component.
